(19) United States
(12) Patent Application Publication
(10) Pub. No.: US 2012/0005028 A1
(43) Pub. Date: Jan. 5, 2012

(54) AD AUCTION OPTIMIZATION

(75) Inventors: Peter Stone, Austin, TX (US); David Pardoe, Austin, TX (US); Doran Chakraborty, Austin, TX (US)

(73) Assignee: The Board of Regents of The University of Texas System, Austin, TX (US)

(21) Appl. No.: 12/827,906

(22) Filed: Jun. 30, 2010

(51) Int. Cl. G06Q 30/00

(52) U.S. Cl. 705/14.71

(57) ABSTRACT

The present disclosure generally relates to ad auction optimization. In some examples, methods, systems, and computer programs for ad auction optimization using machine learning algorithms to estimate a likelihood that a consumer will purchase an advertised product and balance long term and short term goals to determine modeled data for a keyword in an auction are described.

### BACKGROUND

Pay Per Click (PPC) is a model used for advertisement placement on websites. In the PPC model, advertisers pay a host site such as a search engine only when their ad is clicked. Advertisers bid on keyword phrases relevant to their target market and their ad is placed according to the bid. The website displays the ad when a keyword query matches the advertiser's keyword list and the advertiser's bid is highest. Such advertisements are called sponsored links or sponsored ads, and appear adjacent to or above organic results on search engine results pages.

Cost per click (CPC) is the amount of money an advertiser pays the search engine for a single click on its ad that brings one visitor to its website. In bid-based models for determining cost per click, the advertiser considers the potential value of a click from a given source and bids based on that value. The value may be based on the type of individual the advertiser is expecting to receive as a visitor to their website and what the advertiser can gain from that visit, usually revenue, both in the short term as well as in the long term. Factors that can influence PPC campaigns include the target's interest (such as defined by a search term they have entered into a search engine, or the content of a page that they are browsing), intent (e.g., to purchase or not), location (for geo-targeting), and the day and time that they are browsing.

In bid-based models, advertisers compete against other advertisers in a private auction hosted by a publisher or advertising network. Each advertiser informs the host of the maximum amount that they are willing to pay for a given ad spot (often based on a keyword). The auction plays out in an automated fashion every time a visitor triggers the ad spot.

When the ad spot is part of a search engine results page (SERP), the automated auction takes place whenever a search for the keyword that is being bid upon occurs. All bids for the keyword that target the searcher's geo-location, the day and time of the search, etc. are then compared and the winner determined. In situations where there are multiple ad spots, a common occurrence on SERPs, there can be multiple winners whose positions on the page are influenced by the amount each has bid. The ad with the highest bid generally shows up first.

### BRIEF DESCRIPTION OF THE FIGURES

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

In the drawings:

FIG. 1 illustrates an example of a system for ad auction optimization, in accordance with some embodiments of the present disclosure;

FIG. 2 illustrates an example of a process flow through the system for ad auction optimization of FIG. 1, in accordance with some embodiments of the present disclosure;

FIG. 3 illustrates an example of a process flow through a user model of the system for ad auction optimization of FIG. 1, in accordance with some embodiments of the present disclosure;

FIG. 4 illustrates an example of a process flow through an optimization model of the system for ad auction optimization of FIG. 1, in accordance with some embodiments of the present disclosure;

FIG. 5 illustrates a plot showing the average daily balance of the top four agents in a TAC/AA competition;

FIG. 6 is a block diagram illustrating an example computing device that is arranged for ad auction optimization, in accordance with some embodiments of the present disclosure; and

FIG. 7 illustrates a block diagram of an example computer program product that is arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, may be arranged, substituted, combined, separated, and designed in a wide variety of different configurations, all of which are explicitly and implicitly contemplated herein.

This disclosure is drawn, inter alia, to methods, computer programs and systems related to ad auction optimization. More specifically, various techniques, methods and systems for ad auction optimization using machine learning algorithms to estimate a likelihood that a consumer will purchase an advertised product and balance long term and short term goals to determine modeled data for a keyword in an auction are described.

Overview

Sponsored search is one form of Internet advertising available to businesses. In sponsored search, an advertiser pays to have its advertisement displayed alongside search engine results whenever a user searches for a specific keyword or set of keywords. Thus, an advertiser is better able to target those users who might be interested in the advertiser's products. Each of the major search engine (Google, Yahoo, and Microsoft) implements sponsored search. For each keyword, an auction is run in which advertisers bid an amount that they are willing to pay each time their ad is clicked. The order in which the ads are displayed is determined by the ranking of the bids (and possibly other factors such as the probability that the ad will be clicked). Advertisers submit standing bids that they may update at any time, and each time a user searches for the keywords, the auction is run using the current bids.

Running a successful advertising campaign using sponsored search can be difficult. An advertiser must choose keywords of interest and place a bid on each keyword. The bid generally may be based on an understanding of customer behavior, competitors' bidding patterns, and the advertiser's own advertising budget and needs, all of which can change over time. As a result, automated strategies that can bid intelligently, including revising bids in response to observed results, have value to advertisers.

Accordingly, methods, computer programs and systems related to ad auction optimization using machine learning algorithms to estimate a likelihood that a consumer will purchase an advertised product and balance long term and short term goals to determine modeled data for a keyword in an auction are provided herein.

General System for Ad Auction Optimization

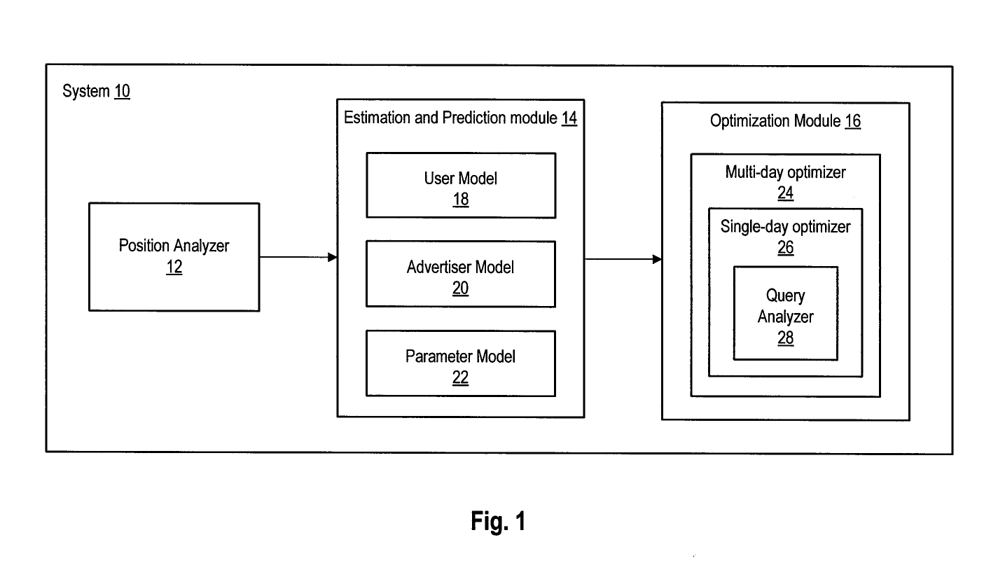

FIG. 1 illustrates an example of a system 10 for ad auction optimization, in accordance with some embodiments of the present disclosure. As shown, the system 10 includes a position analyzer 12, an estimation and prediction module 14, and an optimization module 16. The estimation and prediction module 14 may include a user model 18, an advertiser model 20, and a parameter model 22. The optimization module 16 may include a multi-day optimizer 24, a single-day optimizer 26, and a query analyzer 28. The system 10 is useful for developing a bid strategy for an ad for placement on an advertisement framework. The advertisement framework may be a search engine, such as Google, Yahoo, or Microsoft, or may be research framework such as the Trading Agent Competition Ad Auction game (TAC/AA).

As part of ad placements, information is available to an advertiser. This information may include information that the advertiser may independently develop based on research (research information) as well as information provided directly by the advertisement framework (framework information). Research information may include, for example, results regarding ad placement based on entering of various keywords into the search engine of an advertisement framework. Framework information from the framework may include reports customized to the advertiser based on the bids they have previously submitted to the advertisement framework. A standard report may include information regarding how many impressions (ad placements), clicks, and conversions (purchases) the advertiser received and the average cost per click (CPC).

The position analyzer 12 may be configured to the specifics of the advertisement framework on which the ad is to be placed. Thus, for example, the position analyzer may vary for Google, Microsoft, Yahoo, or TAC/AA. Generally, the position analyzer 12 uses sparse information to develop competitor estimations. The sparse information may include research information or framework information. The position analyzer 12 attempts to deduce what results a competitor is getting on an advertisement framework based on this information.

The estimation and prediction module 14 predicts and models consumers, advertisers, and parameters with the user model 18, advertiser model 20, and parameter model 22, respectively. The estimation and prediction module 14 uses information (research or framework) about past consumer performance to predict the likelihood a consumer will purchase in the future.

The user model 18 predicts information about users (consumers). Generally, having an ad placed is worth more if the consumer who views the ad is more likely to buy upon going to the advertiser's site. Thus, the estimation and prediction module 14 attempts to quantify the likelihood that a consumer is in a purchasing mode when clicking on the ad. The estimation and prediction module 14 predicts where the consumers are and whether the consumers are in a buying/shopping state or are in a browsing state.

The advertiser model 20 predicts information about other advertisers. More specifically, the advertiser model predicts information about how much other bidders are bidding on keywords.

The parameter model 22 predicts information about parameters of the bid. The parameter model 22 maintains estimates of unknown parameters by finding those parameters that best fit the known auction outcomes.

The optimization module 16 balances targeted goals that an advertiser may have for a bid. The targeted goals may be short-term, single day, or long-term, multi-day goals. The optimization module 16 thus may include a multi-day optimizer 24, a single-day optimizer 26, and a query analyzer 28. Single-day and multi-day goals may be considered in view of current inventory as well as production capabilities. Thus, if a retailer has a surplus of inventory on an item, they may have high single-day goals until that surplus is depleted and may then revert to a multi-day goal of maintaining inventory matching production capabilities. The query analyzer 28 uses the information received to compute the expected outcomes of actions, such as how many clicks and conversions may occur for a given query type. Accordingly, the optimization module 16, using the multi-day optimizer 24, single-day optimizer 26, and query analyzer 28, balances maximization of sales, inventory, and multi-day considerations.

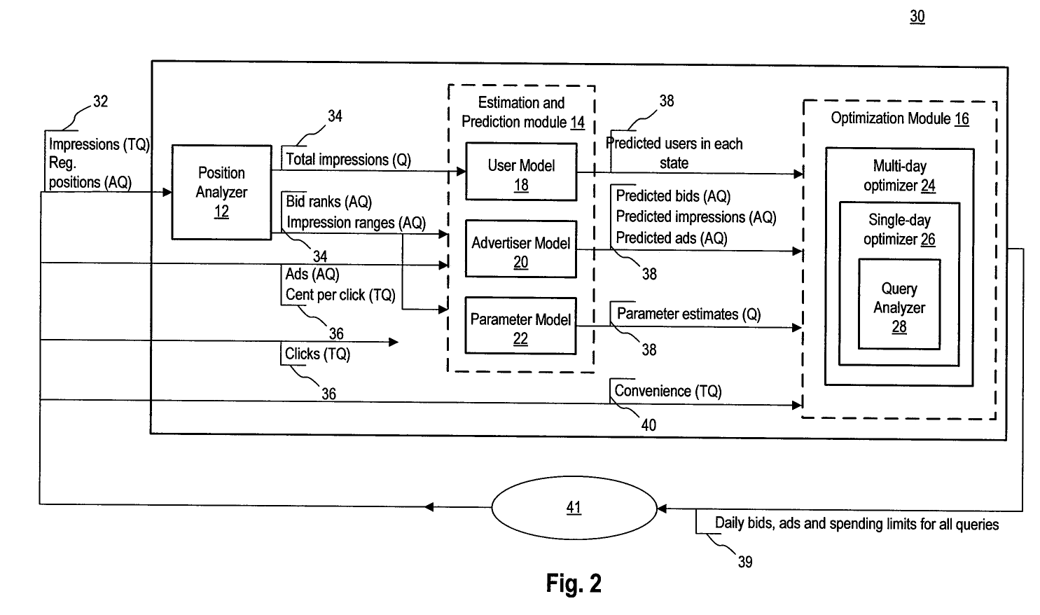

FIG. 2 illustrates an example of a process flow 30 through the system 10 for ad auction optimization, in accordance with some embodiments of the present disclosure. The system 10 uses machine learning algorithms and methods. These methods may include classification algorithms and methods or regression algorithms and methods as appropriate to the modeling being done. Generally speaking, information 32 is input into the position analyzer 12. The position analyzer outputs information 34 to the estimation and prediction module 14. Further information 36 is also input to the estimation and prediction module 14. Using the user model 18, the advertiser model 20, and the parameter model 22, the estimation and prediction module 14 outputs information 38 to the optimization module 16. Information 40 is further input into the optimization module 16. The optimization module 16 then outputs modeled data 39. The modeled data may be input into the framework 41.

The relationship between the modules, including the inputs and outputs of each is shown in FIG. 2. As shown, information 32 is input to the position analyzer 12. This information 32 may comprise impressions or average ad positions. Impressions refer to the number of times an ad is displayed. Average ad positions refer to the placement of the ad when displayed. The information 32 input to the position analyzer 12 may comprise research information or framework information. The position analyzer 12 outputs information 34 including total impressions, bid ranks, and impression ranges to the estimation and prediction module 14.

Information 34 from the position analyzer as well as research information or framework information 36 is input to the estimation and prediction module 14 to perform user, advertiser, and parameter modeling. The modeling may be done using a probabilistic filtering model or machine learning regression algorithm. In a specific implementation, the modeling is done using particle filtering.

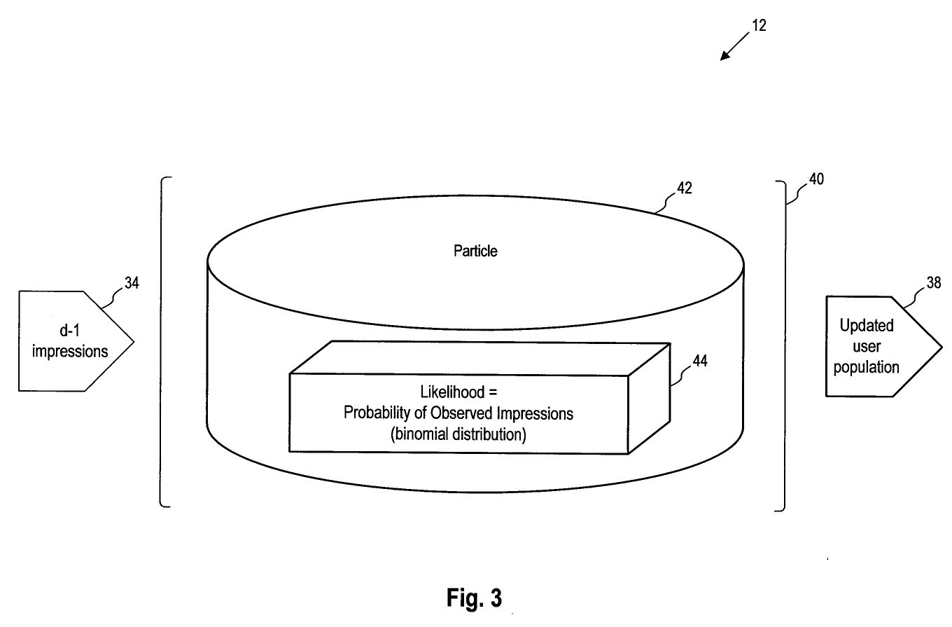

As shown in FIG. 2, the total impressions are input to the user model 18 of the estimation and prediction module 14. FIG. 3 illustrates an example of a process flow through a user model of the system for ad auction optimization of FIG. 1, in accordance with some embodiments of the present disclosure. As discussed with respect to FIG. 2, information 34 is input into the user model 12. In one implementation, the user model 12 includes a particle filter 40. The particle filter 36 may be provided for a specific, particular product. The information 34, including impressions, is input through the particle filter 40 and the particle filter 40 then performs particle filtering for a product that may be the subject of an ad based on the daily impressions. The user model 12 uses the particle 42 to determine the likelihood 44 or probability of observed impressions, for example, by binomial distribution. The data may be updated based on known user transition dynamics. The user model 12 outputs information 38 such as predicted users in each state—purchasing state, browsing state, or other defined state.

Returning to FIG. 2, the bid ranks and impression ranges are input to the advertiser model 20. Further information 36, including research information or framework information, may be input to the advertiser model including. Such information 36 may comprise, for example, ads and cost per click. The advertiser model 20 then estimates bids of other advertisers. In one example, the advertiser model 20 uses two estimators, a first estimator and a second estimator, and averages models from the two estimators. The first estimator may use a particle filter for each query and assume joint distribution over all advertiser bids. The second estimator may assume distribution over discrete bids with separate distribution for each query or advertiser and may thus model probability of bid transactions. The advertiser model 20 may further estimate spending limits. The advertiser model 20 outputs predicted bids, predicted impressions, and predicted ads.

The bid ranks and impression ranges, ads, and cost per click from the advertiser model 20 may further be input into the parameter model 22. Further information 36, including research information or framework information, may be input into the parameter model 22 including. Such information 36 may comprise, for example, clicks. The parameter model then outputs parameter estimates.

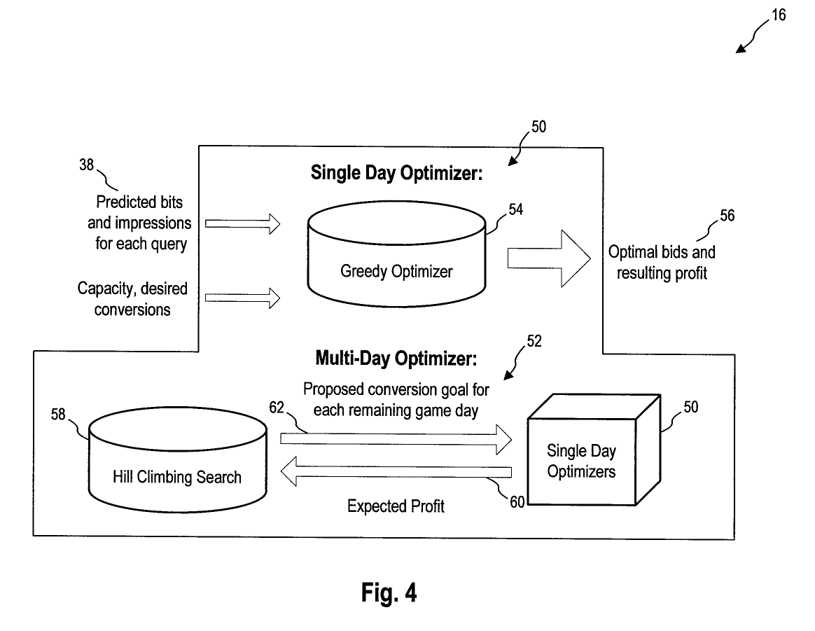

Predicted and modeled information from each of the models 18, 20, 22 is output from the models 18, 20, 22 and input into the optimization module 16. Further information 40, including research information or framework information, may be input into the optimization module 16 including, for example, conversions. Conversions refer to a user making a purchase after clicking an ad. The optimization module 16 then determines bid and spending limits for each ad to maximize future profit. FIG. 4 illustrates an example of a process flow through an optimization model of the system for ad auction optimization of FIG. 1, in accordance with some embodiments of the present disclosure. As shown, the optimization module 16 comprises two optimizers: a single-day optimizer 50 and a multi-day optimizer 52. Any suitable optimization algorithm may be used by each of the single-day optimizer 50 and the multi-day optimizer 52. In specific implementations, the single-day optimizer 50 uses greedy optimization and the multi-day optimizer 52 uses a hill climbing search. Thus, information 38, including predicted bids and impressions as well as capacity and desired conversions, are input into the single day optimizer 50 and a greedy optimizer 54 performs greedy optimization. The output 56 from the single-day optimizer 50 may comprise the optimal bids and resulting profit. The multi-day optimizer 52 uses data from the single-day optimizer 50 and develops the proposed conversion goal for each remaining day of a predetermined multi-day time frame and performs a hill climbing search 58 to determine appropriate daily bids, ads, and spending limits. Accordingly, as shown, an expected profit 60 may be input to the hill climbing search 58 and a proposed conversion goal for each remaining game day 62 may be output from the hill climbing search 58. The query analyzer uses 28 uses data from the multi-day optimizer 24 and single-day optimizer 28 to compute the expected outcomes of actions, such as how many clicks and conversions may occur for a given query type. Returning to FIG. 2, the optimization module 16 thus outputs modeled data 39 to the framework 41. This modeled data 39 may include daily bids, ads, and spending limits for queries.

In various embodiments, not all of the position analyzer 12, estimation and prediction module 14, and optimization module 16 may be provided in the system 10 for ad auction optimization. For example, one system for ad auction optimization may comprise an estimation and prediction module and an optimization module without a position analyzer. Further, in some embodiments, each module may not include each model or component discussed with respect to FIG. 2. For example, an estimation and prediction module may not include each of a user model, an advertiser model, and a parameter model.

Accordingly, in one embodiment, a system for ad auction optimization is provided having an estimation and prediction module and an optimization module. The estimation and prediction module may be configured to receive information and use machine logic on the information to estimate a likelihood a consumer will purchase an advertised item. The estimation and prediction module may further be configured to output estimation and prediction module information. The optimization module may be configured to receive estimation and prediction module information from the estimation and prediction module and other information and use machine logic on the received information to determine a bid amount for a keyword in an auction. The optimization module may include a single-day optimizer and a multi-day optimizer and the optimization module balances short-term and long-term goals in making such determination.

TAC/AA Implementation

TAC/AA Overview

A specific implementation of the system and method provided herein may be applied to the Trading Agent Competition Ad Auction game (TAC/AA). TAC/AA is a competition designed to encourage further research into the area of sponsored search strategies. TAC/AA provides a test bed for studying and prototyping such strategies by providing a competitive environment in which independently created agents can be tested against each other over the course of many simulations in an open academic setting. In the description of the TAC/AA implementation, TacTex refers to a system and method in accordance with the teachings provided herein.

In each TAC/AA game, eight autonomous agents compete as advertisers to see who can make the most profit from selling a limited range of home entertainment products over 60 simulated game days, each lasting 10 seconds. Products are classified by manufacturer (flat, pg, and lioneer) and by component (tv, dvd, and audio) for a total of nine products. Search engine users, the potential customers, submit queries consisting of a manufacturer and a component. Either or both of the manufacture and the component may be null, i.e., missing, in a query. There are thus 16 total query types, divided into three focus levels: F0 (the query with both manufacturer and component null), F1 (the six queries with one null and one specified), and F2 (the nine queries with both specified). Each day, for each of the 16 query types, a keyword auction is run. For each auction, an advertiser submits i) a (real, non-negative) bid indicating the amount it is willing to pay per click, ii) an ad, and iii) a spending limit (optional). Ads may be either targeted (specifying both a manufacturer and product) or generic (specifying neither). The ads of the top five bidders are shown in order, but if an advertiser hits its spending limit (as a result of having its ad clicked enough times), its ad is not shown for the rest of the day, and the ads of all advertisers move up one position. Bids must exceed a small reserve price.

Users: There is a fixed pool of users, each of which remains interested in a specific product throughout the game and only submits queries corresponding to that specific product. Users cycle through states corresponding to the focus levels according to a specified transition model. Users begin in a non-searching (NS) state, and can then transition through a searching (IS) state (which may submit a query of any focus level but will not make a purchase) to one of three buying states (F0, F1, or F2, each of which submits a query of the corresponding focus level and makes a purchase with a probability that increases with the focus), and eventually back to the non-searching state. For each product, the total number of users in any state can vary widely and rapidly.

Click model: Every searching or buying user submits one query per day and then proceeds through the resulting ads in order of advertiser ranking. When an advertiser's ad is shown, it is said to receive an impression, but not all impressions result in clicks. The default user behavior is as follows: If a user submitting query q reaches the ad of advertiser a, the probability of a click is e^{a}_{q}, a hidden parameter drawn randomly at the start of each game. If the user clicks, it converts (make a purchase) with a probability dependent on the user's focus level. For each conversion, the advertiser receives $10. This amount is technically the sales profit before considering advertising costs, but is referred to herein as the agent's revenue. If the user does not convert, it proceeds to the next ad with probability γ_{q}, another randomly drawn, hidden game parameter. Thus, the higher the position of the ad, the more likely it is to be clicked. A number of factors can modify this default behavior. First, if an advertiser's ad is targeted, the click probability may be raised or lowered depending on whether the ad matches the product desired by the user. Second, each advertiser has a component and manufacturer specialty. If the product desired by the user matches the component specialty, the conversion probability is increased, and if it matches the manufacturer specialty, the advertiser's revenue is increased. Finally, the conversion probability decreases if the advertiser has exceeded its capacity, as described below.

Auctions: Ads are ranked using a generalized second price auction. Rather than ranking ads solely by bids, the search engine also considers click probability. If for query type q an advertiser's bid is b_{q} and its default click probability is e^{a}_{q}, then its squashed bid is defined as (e^{a}_{q})^{χ}b_{q}, where χ is a random but known game parameter. Ads are ranked by squashed bid, and each time an advertiser's ad is clicked, it pays the minimum amount it could have bid while still beating the squashed bid of the advertiser ranked below it.

Capacity: Each advertiser is assigned a capacity c which serves as a soft constraint on how many products it can sell (of any type) over a five day period. Whenever an advertiser's ad is clicked, if the number of products n sold over five days (including those sold so far on the current day) exceeds c, then the conversion probability is multiplied by a distribution constraint equal to 0.995^{n-c}. The distribution constraint changes during the day as the advertiser sells more products.

Information: Advertisers must operate in the face of limited information about customers and competitors. For each query type, the advertiser receives a daily report stating how many impressions, clicks, and conversions the advertiser received and the average cost per click (CPC). The only other information available is a report on the ad used by each advertiser and the average position of that ad. An advertiser that wishes to increase its number of clicks would therefore have little information about how much it would cost to increase the position of its ad or how many clicks it might expect in the new position. Advertisers are also unaware of the types (specialties and capacities) of other advertisers.

TABLE 1
Results for the query null:dvd from one game day of the 2009 TAC/AA finals

| | Agent actions | | | | Results | | | | | |
|---|---|---|---|---|---|---|---|---|---|---|
| Advertiser | Bid | Sq. Bid | Ad | Sp. limit | CPC | Imps | Clicks | Convs | Impression range | Avg pos |
| MetroClick | 0.315 | 0.109 | generic | 50.93 | 0.310 | 426 | 164 | 16 | 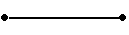 | 1.000 |
| QuakTAC | 0.266 | 0.107 | lioneer:dvd | — | 0.194 | 718 | 156 | 6 | 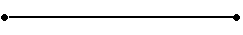 | 1.593 |
| TacTex | 0.235 | 0.091 | generic | 0.236 | 0.201 | 77 | 1 | 0 | 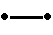 | 3.000 |
| UMTac09 | 0.216 | 0.078 | generic | 7.583 | 0.209 | 700 | 36 | 6 | 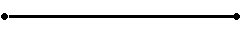 | 2.719 |
| munsey | 0.190 | 0.075 | generic | — | 0.174 | 718 | 16 | 2 | 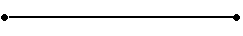 | 3.675 |
| epflagent | 0.214 | 0.068 | generic | — | 0.184 | 641 | 3 | 0 | 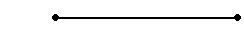 | 4.510 |
| AstonTAC | 0.158 | 0.059 | generic | 500.0 | 0.133 | 292 | 1 | 0 | 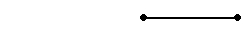 | 4.938 |
| Schlemazl | 0.062 | 0.020 | flat:dvd | 5.617 | — | 0 | 0 | 0 | | — |

Example: Table 1 shows the results for the query null:dvd from a sample game day. The eight advertisers are shown in order of their squashed bids, which differs from the order of the true bids due to differing e^{a}_{q} values. The ads and spending limits (where used) of each agent are also shown. The results of these actions are shown on the right side of the table: the cost per click, impressions, clicks, and conversions. In addition, the impression range column shows a graphical representation of the period for which each advertiser's ad was shown, with the day progressing from left to right. On this day, 718 users submitted the query null:dvd, but due to spending limits, only two agents, QuakTAC and munsey, received the full 718 impressions. TacTex was the first agent to hit its spending limit (after a single click—this was a probe, as described later). At that point, all lower advertisers increased by one position, and since epflagent reached the fifth position, its ad began to be shown. Hence, the impression range column shows epflagent starting where TacTex stopped. Although Schlemazl reaches the fifth position at the end of the day, its ad is not shown because its bid is below the reserve. Finally, the average position for each advertiser is shown. Note that the average positions are not in the same order as the squashed bids, and that the average is only for the period in which the ad was shown (thus never above 5). From this table, the only information available to TacTex was its own row (except for the squashed bid) and the ad and average position columns. Much of TacTex's computational effort is devoted to estimating the rest of this information so that its decisions can be based on as much information as possible.

TacTex Overview

TacTex refers to a specific implementation of a system and method for ad optimization as described herein. TacTex operates by making predictions or estimates concerning various factors (such as unknown game parameters, user populations, and competitor bids) and then by finding the optimal actions given this information. These tasks are divided among the modules described above with reference to FIG. 2, including the position analyzer 12, the estimation and prediction module 14, and the optimization module 16.

Description of FIG. 2 with reference to an implementation for TAC/AA will now be made. At the start of each new day, the game server sends TacTex a report on the results of the previous day. In one implementation, the position analyzer 12 may be a preprocessor that converts some of this information into a more useful format. As applied to TAC/AA, a goal of the position analyzer is to reconstruct the impression range column of Table 1 for each query type.

TacTex then performs all necessary prediction and estimation using the user model 18, advertiser model 20, and parameter model 22 of the estimation and prediction module 14. The user model 18 uses the total number of queries for each query type to estimate the composition of each of the nine user populations. From these estimates, predictions about future user populations can be made. The advertiser model 20 takes information relating to the actions of other advertisers and predicts the actions these advertisers will take in the future. The parameter model 22 maintains estimates of unknown game parameters by finding those parameters that best fit the known auction outcomes.

TacTex uses these predictions and estimates to choose the optimal bids, ads, and spending limits to submit to the game server for the next day. The optimization module 16 includes a multi-day optimizer 24, a single-day optimizer 26, and a query analyzer 28. The query analyzer 28 uses the information received to compute the expected outcomes of actions, such as how many clicks and conversions may occur for a given query type. If there were no distribution constraint, then TacTex could optimize for each query type independently. Because of the distribution constraint, TacTex allocates its available capacity among query types and even among multiple days. The multi-day optimizer 24 divides capacity among the remainder of the game days, and it calls the single-day optimizer 26 to divide each day's capacity among query types using the information provided by the Query Analyzer.

Position Analyzer

In one implementation, for each query type, the position analyzer 12 takes the average advertiser positions and attempts to extract i) the ranking of the squashed bids, and ii) the first and last impression for each advertiser. Each advertiser's average position can be expressed as a function of the bid rankings and first and last impressions of all other advertisers, and while this system of equations cannot be solved directly, it is possible to efficiently search the space of unknown values to find a correct or nearly correct solution.

Estimation and Prediction Module

User Model

In one implementation, the user model 18 maintains estimates of the user population states by using a particle filter for each of the nine populations. Each of the 1000 particles used per filter represents a distribution of the population's 10,000 users among the user states (NS, IS, F0, F1, and F2). At the start of the game, the initial particles reflect the possible populations resulting from the game server's initialization process. Each succeeding day, a new set of particles is generated from the old. For each new particle to be generated, an old particle is selected at random based on weight, and the new particle's user distribution is randomly generated from the old particle based on the user transition dynamics.

Although many observations depend on the user populations, informative are the total impressions for each of the nine F2 queries. All F2 users submit an F2 query, and each IS user has a ⅓ probability of doing so. The number of F2 impressions resulting from a given user population thus follows a binomial distribution, and the user model 18 uses this fact to weight each particle according to its relative likelihood.

The resulting set of particles represents the estimated probability distribution over the user population state on the previous day. To obtain the expected user population n days in the future, the user model 12 updates each particle n+1 times according to the user transition dynamics and takes the weighted average of the particles.

Advertiser Model

The advertiser model 20 makes three types of predictions about the actions of the competing advertisers: impression predictions, ad predictions, and advertiser bid estimations.

Impression predictions: For each query type, the advertiser model 20 predicts the maximum number of impressions that each advertiser could receive before hitting its spending limit. In cases in which an advertiser did not hit its spending limit by the previous day's final impression, the advertiser model 20 assumes that the advertiser effectively had no spending limit and will also not hit its spending limit on the coming day. Otherwise, the prediction is set to the number of impressions received by the advertiser on the previous day.

Ad predictions: The advertiser model 20 also predicts the ads (targeted or generic) that other advertisers will choose. For each query type, the advertiser model 20 maintains a count for the ads it has seen so far from each advertiser. The predicted ad for that query is then the majority ad, i.e., the ad having the highest count amongst all posted ads for that query type.

Advertiser bid estimation: The third task performed by the advertiser model 20 is to maintain estimates of the bids submitted by each advertiser for each query and then to predict what future bids will be. Advertiser bid estimation can be complicated because the bidding dynamics of other advertisers are unknown—while bids often change only gradually, it is not uncommon for large jumps to occur. In addition, the advertiser model 20 receives only partial information about the bids of other advertisers (the bid ranks and TacTex's CPC).

Bid estimation may be done by one or more bid estimators. In one implementation, an ensemble approach that averages the output of the two estimators is used. In alternative implementations, only one estimator may be used. In an implementation using two bid estimators, a first bid estimator may model all advertisers' bids jointly and the second bid estimator may bid independently.

First bid estimator: The first bid estimator uses particle filtering to estimate the bids of other advertisers. One particle filter may be used for each of the 16 query types. Each of the 1000 particles per filter represents one set of bids for all other advertisers for that query type. Associated with the particles is a probability distribution that gives the likelihood of each particle representing the current state. On each new day, each particle filter samples from the underlying distribution to obtain the next set of particles. Then it updates each particle based on the observations received that day, i.e., the cost per click and bid rankings. Once the particles have been updated, the filter recomputes the probability distribution for the new set of particles.

The sampling step is straightforward. The next step in particle filtering is to update each particle using the known dynamics. In the absence of such known dynamics, a non-standard particle filter may be used for the update. Let cpcₜ₊₁ and rₜ₊₁ be the cost per click and ranking for that query seen on day t+1. These values may be used to reset some of the bids made by other advertisers in some particles (as appropriate) in an attempt to improve the respective particle. On each iteration of the update, the bid, b^{x}ₜ₊₁ of an advertiser x is adjusted while holding the bids of the other advertisers fixed. The bids are adjusted for only those cases where the order of a bid is incorrect with respect to the known bid ranking. The two cases where the order is correct and there is no need for bid adjustment are:

rₜ₊₁^{x}>(rₜ₊₁^{TacTex}+1) [symbol] bₜ₊₁^{x}<cpcₜ₊₁

rₜ₊₁^{x}<rₜ₊₁^{TacTex} [symbol] bₜ₊₁^{x}>bₜ₊₁^{TacTex} (1)

The conditions when b^{x}ₜ₊₁ is to be updated, and how these updates are made, are discussed below. rand(a, b) denotes a random draw from the range (a, b). z denotes the particle and z(r) denotes the bid of the advertiser ranked r in z.

$${b}_{t + 1}^{x} = \{ \begin{matrix}{cpc}_{t + 1} & if {r}_{t + 1}^{x} = {r}_{t + 1}^{TacTex} + 1 \\ rand ( 0 , least bid value in z ) & if {r}_{t + 1}^{x} = undefined \\ rand ( z ( {r}_{t + 1}^{x} + 1 ) , z ( {r}_{t + 1}^{x} - 1 ) ) & otherwise\end{matrix}$$

Note that the “otherwise” case excludes the conditions mentioned in 1. The whole process is repeated a fixed number of times, holding one advertiser fixed each time, with each iteration improving upon the former (20 iterations is sufficient). At the end of this update step, the particle has closer predictions of other advertiser bids.

The probability distribution of the sampled particles is then recomputed. Although the true likelihood of a particle whose ranking does not match the true ranking rₜ is zero, there may be few particles with the correct ranking, a likelihood function thus may be used to give some weight to all particles. The difference of ranking for each advertiser is computed from the two available sources, i.e., rₜ and the rank from z. For a distance δ, κ(δ)=exp(−δ²/4.9). The likelihood of each particle is set to the product of these κ(δ) values over all advertisers, and thus the particles whose predicted rankings are closer to rₜ get assigned higher values. These values are normalized over all 1000 particles to give the true probability distribution captured by the particles.

Second bid estimator: The second approach tries to compute each advertiser's bid separately. The bids are represented as discretized values rather than a changing set of particles. The bid space [0, 3.75] is discretized into values v₁ through v₁₀₀ by setting vᵢ=2^{i/25-2}−0.25 (thus v₅₀=0.75). Discretizing the bid space in this way allows better coverage of low bids, which are most common, while still maintaining the ability to represent very high bids.

On day t+1, for each advertiser x, we wish to estimate the distribution of the new bid, b^{x}ₜ₊₁, over these discrete v values, conditional on the observed ranking rₜ₊₁, previous bids b^{x}₁ . . . b^{x}ₜ, and the bids of other advertisers, B^{-x}ₜ₊₁. We make the simplifying assumptions that rₜ₊₁ and b^{x}₁ . . . b^{x}ₜ are conditionally independent given b^{x}ₜ₊₁, and that B^{-x}ₜ₊₁ and b^{x}₁ . . . b^{x}ₜ are independent. Applying Bayes' rule twice and rearranging, the following equation may be derived:

Pr(bₜ₊₁^{x}=vᵢ|rₜ₊₁,Bₜ₊₁^{-x},b₁^{x} . . . bₜ^{x})∝

Pr(rₜ₊₁|Bₜ₊₁^{-x}bₜ₊₁^{x}=vᵢ)Pr(bₜ₊₁^{x}=vᵢ|b₁^{x} . . . bₜ^{x}) (2)

The first term in the R.H.S of Equation 2 is the probability of the observation while the second term is the transition model of bids for x, both unknown.

Bid transitions may be modeled by assuming that bids change in one of 3 ways. First, with 0.1 probability, b^{x}ₜ₊₁ jumps uniformly randomly to one of the vᵢ values. This case covers sudden jumps that are difficult to model. Next, with 0.5 probability, b^{x}ₜ₊₁ changes only slightly from b^{x}ₜ. The probability of changing from vᵢ to vⱼ is assumed to be proportional to φ_{0,6}(|i−j|), where φ0,6 is the density function of the zero-mean normal distribution with variance 6. Finally, it is assumed that with 0.4 probability, the bid changes according to a similar distribution, but the change is with respect to the bid 5 days ago, b^{x}ₜ₋₄. This case captures the fact that bids often follow 5 day cycles due to the 5 day capacity window. Let tr(j, i) denote the resulting probability of the bid transitioning to vᵢ from vⱼ using the above normal distribution and normalizing. Then, summing the three cases gives us the following: Pr(b^{x}ₜ₊₁=vᵢ|b^{x}ₜ=vⱼ, b^{x}ₜ₋₄=vₖ)=0.001+0.5tr(j, i)+0.4tr(k, i). The estimate for b^{x}₁ is initialized to a distribution consistent with observed game data, and when t<5, we substitute b₁ for b^{x}ₜ₋₄. The probabilities for the three cases were chosen to provide robustness to a variety of agent behaviors in pre-competition experiments.

The observation probabilities are now conditioned on a single advertiser's bid, rather than a set of bids as in the first bid filter. Let y be another advertiser in the game apart from x. If advertiser y is TacTex, then we know the bid; otherwise we have a distribution representing our estimate of the bid for y. Thus the conditional probability of the set of rankings rₜ₊₁ given a fixed b^{x}ₜ₊₁=vᵢ and a fixed value of the distribution B^{-x}ₜ₊₁ is:

$$P = {\prod }_{∀ y \neq x} \{ \begin{matrix}Pr ( {b}_{t + 1}^{y} > {v}_{i} ) & if {r}_{t + 1}^{x} > {r}_{t + 1}^{y} , \\ Pr ( {b}_{t + 1}^{y} < {v}_{i} ) & if {r}_{t + 1}^{x} < {r}_{t + 1}^{y} , \\ 1 & otherwise\end{matrix} \qquad ( 3 )$$

where P denotes Pr(rₜ₊₁|b^{x}ₜ₊₁=v₁, B^{-x}ₜ₊₁). Note that ranks will only be equal if neither advertiser had any impressions; in this case no information is available about the relative bids. Also, whenever y is TacTex, the R.H.S will be 1 or 0 since the TacTexb bid is known. Finally, while B^{-x}ₜ₊₁ is treated as if it were known, these are the other advertisers' bids that TacTex estimates simultaneously. Equation 2 thus may be applied for 10 iterations, using the latest estimates for each bid distribution such that this results in sufficient convergence in testing.

Parameter Model

Recall that for each query type q, the parameter γ_{q} represents the probability that a user will progress from one ad to the next, while each advertiser a has a parameter e^{a}_{q} that affects the probability of a user clicking its ad. Given the bid rankings and impression ranges computed by the position analyzer 12 and the user model 18's population estimate, the distribution over the number of clicks that TacTex would receive for any set of these parameter values may be determined. The parameter model 22 maintains a joint distribution over (γq, e^{TacTex}_{q}) pairs by discretizing the possible space of values uniformly and setting the likelihood of each pair to be proportional to the product of the probabilities of each day's number of clicks. There is insufficient information to effectively estimate e^{a}_{q} values of other advertisers, and they are assumed equal the mean possible value.

Optimization Module

The position analyzer 12 and estimation and prediction module 14 estimate the game state and make predictions about the future. The optimization module 16 uses this information to select actions. In particular, each day TacTex must choose bids, ads, and spending limits for each query. One factor in the optimization process is the distribution constraint. While there is no hard cap on capacity, exceeding a certain number of conversions results in a reduced conversion rate. Beyond some point, marginal returns per conversion can become negative. As a result, TacTex performs optimization by reasoning about conversions and then choosing actions expected to result in those conversions, rather than reasoning directly in the space of possible actions.

The optimization process comprises three levels: a multi-day optimizer (MDO) 24, a single-day optimizer (SDO) 26, and a query analyzer (QA) 28. To maximize profit for the entire game, not a single game day, the top-level decision made is how many conversions to target on each remaining game day, and this decision is made by the MDO 24. Computing the expected profit for a given day and conversion target comprises deciding how to divide the conversions among the 16 query types, and the MDO 24 calls the SDO 26 to perform this task. Finally, the SDO 26 calls the QA 28 to i) determine the bid, ad, and spending limit that are expected to result in a given number of conversions, and ii) compute the expected cost and revenue from those conversions.

Query Analyzer

For any given bid, ad, and spending limit, the expected cost, revenue, and conversions may be determined from a specific query type. In one implementation, the QA 28 does this by taking the expected user population, iterating through all impressions, computing the TacTex position and CPC, and then computing the probability that the user i) reaches our ad, ii) clicks on it, and iii) converts. Generally, the QA 28 is given a conversion target and needs to determine the bid, ad, and spending limit that will produce those conversions in the most profitable way. Up to a certain point, raising either the bid or the spending limit will increase the number of conversions, while the effect of ad choice depends on the user population, so there may be a number of ways to reach a given number of conversions.

To simplify the estimation, no spending limits may be set. During the course of a day, the expected profit per impression can only increase as other agents hit their spending limits, and so it is desirable to receive all possible impressions in a day. Also, the cost paid per conversion tends to be higher at smaller positions—the slightly higher conversion rate at small positions is usually not enough to compensate for the higher CPC. It therefore may be preferable to control conversions using the bid rather than the spending limit.

For any given bid, the relevant ads may be evaluated and one picked that gives the highest profit per conversion. As a result, the QA 28's primary task is to determine the bid that will result in the desired number of conversions. There is one difficulty remaining, however: because our prediction for each advertiser's bid is a point estimate, any bid between the nth and n+1 st predicted bids will result in the same position, n+1, and the function mapping bids to conversions will be a step function. In reality, there is uncertainty about the bids of other advertisers, and this function should be continuous and monotonically increasing. A function may be created by linearly interpolating between the expected results for each position. In particular, the number of conversions expected for the nth position will result from bidding the average of the n−1st and nth bid. For n=1, a bid 10% above the predicted highest bid may be used, and for n=8, a bid 10% below the predicted lowest bid may be used. Functions for cost and revenue may be generated in the same way.

The complete procedure followed by the QA 28 for each query type q is therefore as follows. First, the eight bids (along with corresponding optimal ads) that correspond to the eight possible positions are determined, the expected conversions, cost, and revenue for each are then determined. Next, using linear interpolation, functions mapping bids to conversions, cost, and revenue are created. Finally, for a conversion target c, the bid resulting in the target from the conversions function is determined and the resulting cost (cost_{q}(c)) and revenue (revenue_{q}(c)) are determined from the corresponding functions. The ad to use is the ad corresponding to the closest of the eight bids.

Single-Day Optimizer

Using this information about each query type, the SDO 26 can now determine the optimal number of conversions to target for each query type given a total daily conversion target c and the initial capacity used u. The initial capacity used (the sum from the past four days), along with the total conversion target, determines the distribution constraint, which can in turn impact the profit from each conversion and the optimal solution.

Computing the precise impact of the distribution constraint may be difficult because it decreases after each conversion, meaning that the time of a conversion must be known to compute its profit. This problem may be solved by making the simplifying assumption that the day's average distribution constraint applies to each conversion. This value may be denoted ⁻d(u, c) because it can be computed from the initial capacity used and the total conversion target; in fact, all possible d(u, c) values may be precomputed before the game begins. The goal of the SDO 26 is thus to find values of c_{q} maximizing Σ_{q}[⁻d(u, c)revenue_{q}(c_{q})−cost_{q}(c_{q})], where the c_{q} values correspond to the query types and sum to c. While c conversions are targeted, only ⁻d(u, c)c conversions are expected. In general reasoning is performed in terms of conversions before adjusting for the distribution constraint, and so for clarity the term adjusted conversions is used when referring to the actual number of resulting conversions. Note that u is expressed in terms of adjusted conversions, while c is not.

Optimization next comprises allocating the total conversion target among the queries so as to maximize profit. In one implementation, the SDO 26 does this using a nearly-optimal greedy solution that repeatedly adds conversions from the most profitable query type. For each query type, the number of additional conversions (bounded above by the number of conversions remaining before hitting the target) is determined that maximizes the average profit per additional conversion. This number may be more than one, as the marginal profit per conversion is not necessarily monotonically decreasing. The conversions from the query type with the highest average profit is then added. This greedy approach is not guaranteed to be optimal, but tests show that the resulting expected profit differs from the results of an optimal (but much slower) dynamic programming approach by less than 0.1% on average.

Multi-Day Optimizer

The SDO 26 determines bids for any given conversion target and amount of capacity already used. Determining the bids to submit for the next day therefore requires only choosing the conversion target. Because the bids submitted today affect not only tomorrow's profit but also the capacity remaining on future days, the conversion target is not chosen myopically. In order to maximize expected profit over the remainder of the game, the actions to be taken over all remaining days are considered.

The MDO 24 operates by finding the optimal set of conversion targets for the remainder of the game. The expected profit from any set of conversion targets can be determined by successively applying the SDO 26 to each remaining game day. The goal of the MDO on day d is therefore to find the conversion targets cₜ maximizing Σ⁵⁹_{t=d+1} SDOₜ(cₜ, uₜ), where SDOₜ returns the expected profit from applying the SDO on day t, and uₜ represents the total adjusted conversions over four days preceding t (which can be computed from the cₜ values). Planning for the entire game may involve calling the QA 28 (and thus predicting the bids of other agents) for all remaining game days, not only the next day. In some implementations, TacTex assumes that the bids predicted for the next day persist for the rest of the game.

In one implementation, the MDO 24 uses a form of hill climbing search for optimization. Each cₜ value is set at one-fifth of TacTex's capacity. Then for all t, the value of cₜ may be increased or decreased by one and the expected profit in each case computed. The most profitable deviation over all t may then be chosen. This process repeats until no deviation is profitable. Again, the performance of this approach is comparable to that of an optimal but slow dynamic programming approach.

Once the optimal set of conversion targets is found, the MDO 24 takes tomorrow's conversion target and submits the bids determined by the SDO 26. Essentially, the rest of the game is planned for and the first step of this plan is taken. On the next day, this process may be repeated this process using updated information.

There is one remaining special case. In some cases, an advertiser may not be interested in bidding on a particular query. When this happens, TacTex submits a probe bid designed to provide information about the bids of other advertisers. The bid chosen is one that is expected to be the nth ranked bid, where n is the rank between 2 and 6 that has been hit least recently. A spending limit is set equal to the bid so that it is likely only a single click will be received.

### EXAMPLE

For the purposes of the examples set forth below, TacTex refers to a specific implementation of a system and method for ad optimization as described herein.

### Example

### 9.1 2009 Competition

The first annual TAC/AA competition was held over two days at IJCAI 2009. All 15 qualifying agents participated in a round-robin style semifinal round, and then the top eight agents advanced to a final round where each agent participated in all 80 games.

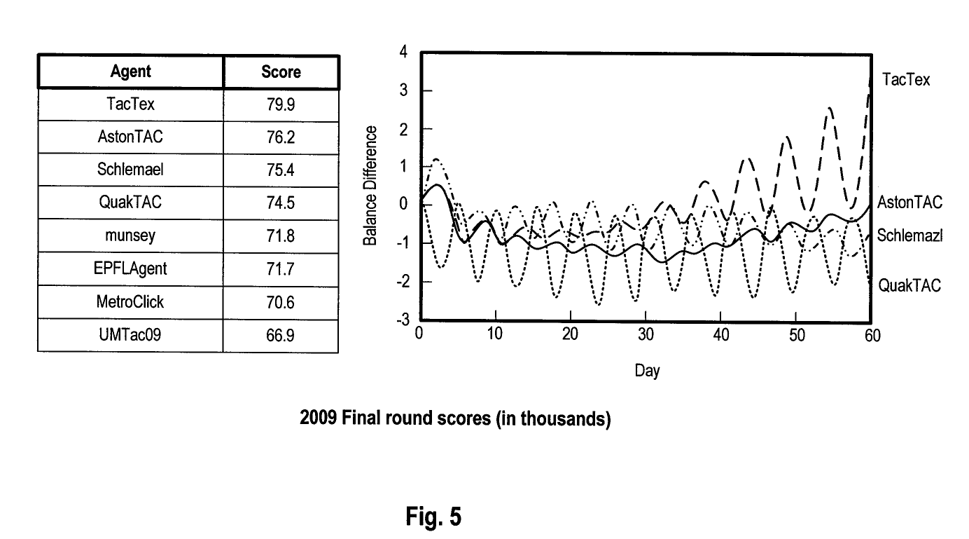

TacTex finished first in both rounds. The scores (i.e., average ending balances) from the final round are shown in the table in FIG. 2. A Wilcoxon two-sample test shows that the difference in score between TacTex and each other agent is statistically significant (p<0.05 in each case). FIG. 5 illustrates a plot showing the average daily balance of the top four agents in a TAC/AA competition. As shown, the 1293 per day (the average daily profit of the second place agent) is subtracted from each balance to improve visibility. Two things are apparent from this plot. First, scores tend to oscillate rather than increase smoothly. This oscillation is a consequence of the 5-day capacity window; if an agent has a large number of conversions on one day (frequently the very first day), it will have reduced capacity for four days, and then the heavy day slides out of the window. There is a similar end game effect, as there is no benefit to saving capacity beyond the last day. TacTex is especially effective at ending on an upswing due to the multi-day optimizer. Second, TacTex does not pull away from the other agents until the second half of the game. One possible explanation is that bidding behaviors converge to some degree over the course of a game, and so TacTex's ability to make accurate predictions improves.

Compared to other agents, TacTex typically had fewer conversions but had a higher profit per conversion (at least 6% higher than any other agent). AstonTAC and Schlemazl focused on selling those products that matched their manufacturer specialty, which gives a revenue bonus. As a result, their average revenue per conversion was slightly higher that TacTex's, but their clicks tended to come from higher positions and thus their CPCs were higher than TacTex's. The reverse was true for all other agents: they had lower CPCs than TacTex, but much lower average revenue per conversion. It appears that TacTex struck the right balance between targeting high revenue conversions and taking advantage of other sales opportunities.

### Examples 1-20

### Using Data from 9.1 2009 Competition Example

Although the competition victory discussed in the 9.1 2009 Competition Example suggests that the overall design of TacTex is sound, it provides little information about the relative importance of the individual components. After the competition of Example 1, most teams submitted agent binaries to the TAC Agent Repository2. Experiments were run using these binaries by changing certain portions of TacTex and observing the effect on performance.

The impact of a change to TacTex is measured by running two sets of 50 games: one with the original TacTex, and one with a modified version. The other seven agents are the best available agents from the repository. To improve the ability to evaluate the statistical significance of the results, the game server is modified so that the main random factors (game parameters, advertiser capacities and specialties, and the random draws primarily responsible for determining user population transitions) are identical between corresponding pairs of games. Accordingly, Wilcoxon matched-pairs signed-ranks test may be used instead of an unpaired test. Table 2 shows the results of our experiments.

TABLE 2
Experimental results

| | | | |
|---|---|---|---|
| # | Description | Diff. | p |

Advertiser Model

| | | | |
|---|---|---|---|
| 1 | bid estimator 1 | −284 | .150 |
| 2 | bid estimator 2 | −306 | .113 |
| 3 | bids * 0.9 | −536 | .077 |
| 4 | bids * 1.1 | −678 | .010 |
| 5 | bids * r(0.9, 1.1) | −501 | .046 |
| 6 | all impressions | −3438 | .000 |
| 7 | impressions * 0.9 | −772 | .008 |

Other

| | | | |
|---|---|---|---|
| 8 | no User Model | −896 | .001 |
| 9 | no Par. Model | −254 | .133 |
| 10 | no probing | −812 | .004 |

Optimization

| | | | |
|---|---|---|---|
| 11 | maintain cap. | −4257 | .000 |
| 12 | constant conv. | −7362 | .000 |
| 13 | conv. * 0.9 | −287 | .174 |
| 14 | conv. * 1.1 | +62 | .596 |
| 15 | conv. * 1.2 | −1024 | .000 |
| 16 | bids * 0.9 | −453 | .039 |
| 17 | bids * 1.1 | −704 | .000 |
| 18 | bids * r(0.9, 1.1) | −425 | .038 |
| 19 | all generic ads | −2351 | .000 |
| 20 | all targeted ads | −87 | .992 |

For each experiment, a reference number, a brief description, the difference in score (a ‘−’ means the score of the modified agent was lower), and the p-value indicating the significance is given. Experiments are divided into groups corresponding to different parts of TacTex.

The first group of experiments concerns the TacTex advertiser model. In experiments 1 and 2, only one of the first bid estimator and the second bid estimator are used instead of averaging the two. Although both estimators appear to perform well on their own, a small increase in score is observed from the combination. In experiments 3-5, the advertiser model's predicted bids for each advertiser are multiplied by 0.9, 1.1, or a random number chosen uniformly from the range [0.9, 1.1], respectively. Again, a small decrease in score is observed from each change. These experiments show that TacTex predictions are sufficiently helpful such that small changes can impact performance negatively.

Finally, the advertiser model's predictions of the number of impressions advertisers will receive is examined. In experiment 6, it is assumed that advertisers use no spending limits (i.e., they receive all possible impressions). In experiment 7, when predicting that an advertiser will use a spending limit, the predicted impressions are multiplied by 0.9. Both changes result in a large drop in score, showing that impression predictions impact performance of the system and method.

The next group of experiments do not fit a specific category. In experiment 8, the predictions of the user model are replaced with the average user populations expected. This results in a fairly large drop in score. Similarly, in experiment 9 the estimates from the parameter model are replaced with the expected values. This results in a smaller score reduction. In experiment 10, all probe bids are replaced with zero bids. This is detrimental to performance. The information lost from these changes appears to be important to TacTex, and the last experiment shows that a query type that does not attract attention from TacTex on one day may still become a source of profit in the future.

The last group of experiments concerns optimization. Experiments 11 and 12 show the importance of planning over multiple days. In experiment 11, the next day's conversion target is chosen such that the total conversions over the last five days are 1.4 times capacity (the average amount used by the unaltered TacTex). In experiment 12, each day's conversion target is set to be ⅕ of 1.4 times the capacity. Both changes cause an extremely large drop in score despite the fact that TacTex has roughly the same number of conversions. In experiments 13-15, the next day's conversion target is multiplied by 0.9, 1.1, and 1.2, respectively. Experiments 13 and 15 result in score reductions as expected; however, multiplying the conversion target by 1.1 actually results in an increase in score, although not a significant one. One explanation for this result would be if TacTex consistently received fewer conversions than expected, but that is not the case. Another explanation for this result is that it may be less harmful to sell too much than too little, and because TacTex will rarely hit its conversion target exactly, it would be safer to target a few extra conversions. In any case, experiments 11-15 suggest that the multi-day optimizer is highly effective in choosing conversion targets.

Experiments 16-18 concern the bids generated by the query analyzer at the end of the optimization process. These bids are multiplied by 0.9, 1.1, or a random number chosen uniformly from the range [0.9, 1.1], respectively. In each case there is a moderately large score reduction. Accordingly, the query analyzer appears to be successful at providing useful information about bid selection.

Experiments 19 and 20 concern ad selection. In experiment 19, only generic ads are used, and in experiment 20 only targeted ads are used, where the manufacturer and component match the query when present or TacTex's specialty when null. The results show that ad selection can impact score, but it does not appear that choosing optimal ads (which are usually targeted) is significantly better than simply always using targeted ads.

The main conclusion from these experiments is that each of the analyzed components of TacTex may contribute to the overall performance of the agent.

Computing Devices

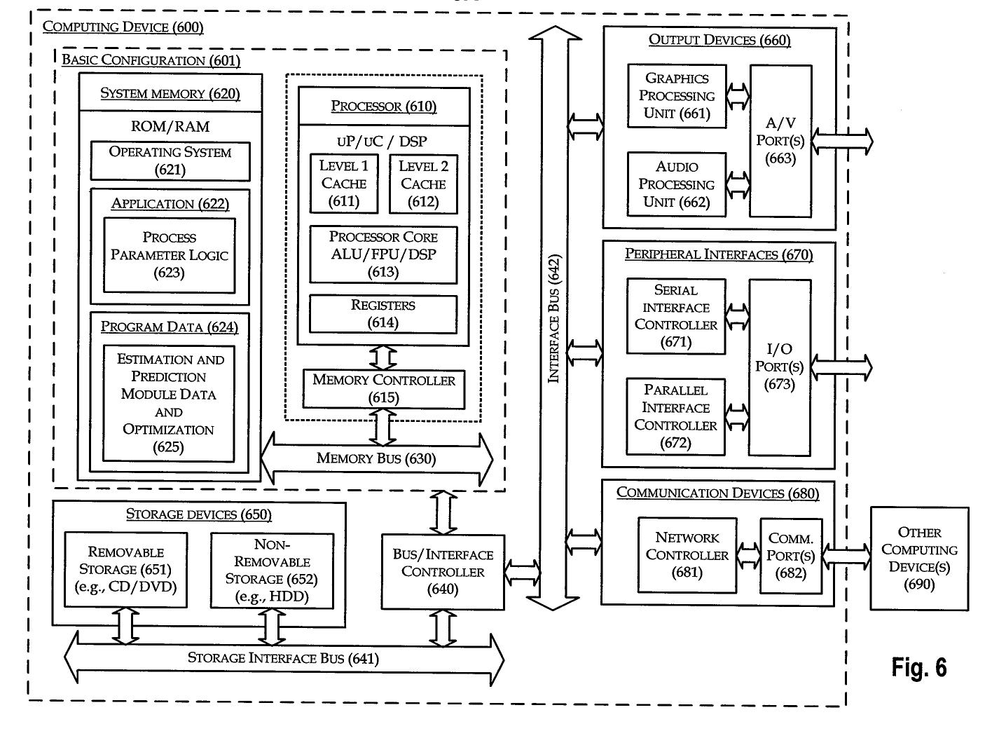

FIG. 6 is a block diagram illustrating an example computing device 600 that is arranged for ad auction optimization, in accordance with some embodiments of the present disclosure. Computing device 600 is one example device that may be utilized as a controller for one or more of the processes described herein. In a very basic configuration 601, computing device 600 typically includes one or more processors 610 and system memory 620. A memory bus 630 may be used for communicating between the processor 610 and the system memory 620.

Depending on the desired configuration, processor 610 may be of any type including but not limited to a microprocessor (μP), a microcontroller (μC), a digital signal processor (DSP), or any combination thereof. Processor 610 may include one more levels of caching, such as a level one cache 611 and a level two cache 612, a processor core 613, and registers 614. An example processor core 613 may include an arithmetic logic unit (ALU), a floating point unit (FPU), a digital signal processing core (DSP Core), or any combination thereof. An example memory controller 615 may also be used with the processor 610, or in some implementations the memory controller 615 may be an internal part of the processor 610.

Depending on the desired configuration, the system memory 620 may be of any type including but not limited to volatile memory (such as RAM), non-volatile memory (such as ROM, flash memory, etc.) or any combination thereof. System memory 620 may include an operating system 621, one or more applications 622, and program data 624. Application 622 may include a process parameter logic 623 for controlling process parameters for ad auction optimization. Program Data 624 includes estimation and prediction module data and optimization module data 625. In some embodiments, application 622 may be arranged to operate with program data 624 on an operating system 621 such that the computer system may be operably associated with a framework for ad auction and placement. This described basic configuration is illustrated in FIG. 6 by those components within dashed line 601.

Computing device 600 may have additional features or functionality, and additional interfaces to facilitate communications between the basic configuration 601 and any required devices and interfaces. For example, a bus/interface controller 640 may be used to facilitate communications between the basic configuration 601 and one or more data storage devices 650 via a storage interface bus 641. The data storage devices 650 may be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of device 600.

Computing device 600 may also include an interface bus 642 for facilitating communication from various interface devices (e.g., output interfaces, peripheral interfaces, and communication interfaces) to the basic configuration 601 via the bus/interface controller 640. Example output devices 660 include a graphics processing unit 661 and an audio processing unit 662, which may be configured to communicate to various external devices such as a display or speakers via one or more A/V ports 663. Example peripheral interfaces 670 include a serial interface controller 671 or a parallel interface controller 672, which may be configured to communicate with external devices such as input devices (e.g., keyboard, mouse, pen, voice input device, touch input device, etc.) or other peripheral devices (e.g., printer, scanner, etc.) via one or more I/O ports 673. An example communication device 680 includes a network controller 681, which may be arranged to facilitate communications with one or more other computing devices 690 over a network communication link via one or more communication ports 682.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

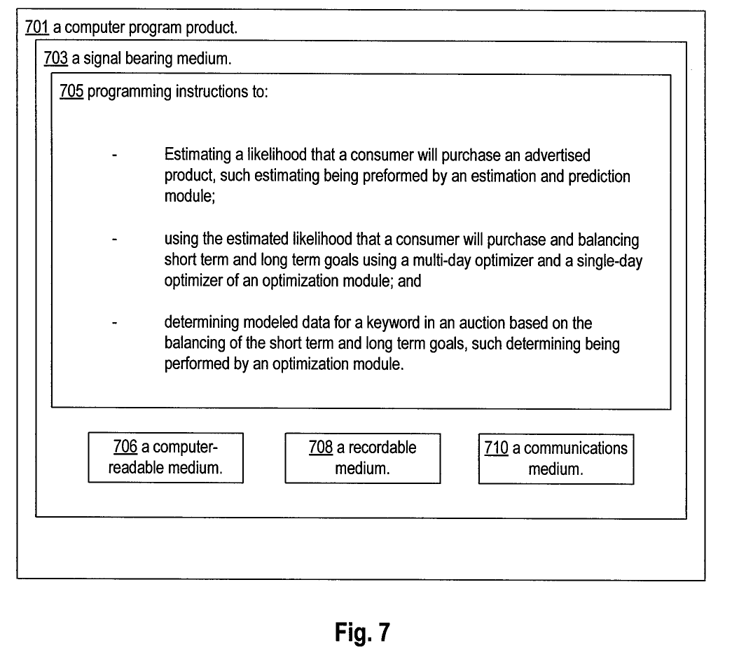

FIG. 7 illustrates a block diagram of an example computer program product 700 that is arranged in accordance with at least some embodiments of the present disclosure. In some examples, computer program product 700 includes a signal bearing medium 702 that may also include computer executable instructions 705. Computer executable instructions 705 may be arranged to provide instructions for ad auction optimization. Such instructions may include, for example, instructions relating to estimating a likelihood that a consumer will purchase an advertised product, such estimating being performed by an estimation and prediction module, using the estimated likelihood that a consumer will purchase and balancing short term and long term goals using a multi-day optimizer and a single-day optimizer of an optimization module, and determining modeled data for a keyword in an auction based on the balancing of the short term and long term goals, such determining being performed by an optimization module. Generally, the computer executable instructions may include instructions for performing any steps of the ad auction optimization system and method described herein.

Also depicted in FIG. 7, in some examples, computer product 700 may include one or more of a computer readable medium 706, a recordable medium 708 and a communications medium 710. The dotted boxes around these elements may depict different types of mediums that may be included within, but not limited to, signal bearing medium 702. These types of mediums may distribute computer executable instructions 705 to be executed by computer devices including processors, logic and/or other facility for executing such instructions. Computer readable medium 706 and recordable medium 708 may include, but are not limited to, a flexible disk, a hard disk drive (HDD), a Compact Disc (CD), a Digital Video Disk (DVD), a digital tape, a computer memory, etc. Communications medium 710 may include, but is not limited to, a digital and/or an analog communication medium (e.g., a fiber optic cable, a waveguide, a wired communication link, a wireless communication link, etc.).

The present disclosure is not to be limited in terms of the particular examples described in this application, which are intended as illustrations of various aspects. Many modifications and variations may be made without departing from its spirit and scope, as will be apparent to those skilled in the art. Functionally to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular examples only, and is not intended to be limiting. These are for illustration only and are not intended to be limiting.

The foregoing describes various examples of systems and methods for ad auction optimization. Following are specific examples of systems and methods for ad auction optimization. These are for illustration only and are not intended to be limiting.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically matable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like include the number recited and refer to ranges which may be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for ad auction optimization comprising:
an estimation and prediction module configured to receive information and use machine logic on the information to estimate a likelihood a consumer will purchase an advertised item, the estimation and prediction module being further configured to output estimation and prediction module information; and
an optimization module configured to receive estimation and prediction module information from the estimation and prediction module and other information and use machine logic on the received information to determine a bid amount for a keyword in an auction, wherein the optimization module includes a single-day optimizer and a multi-day optimizer and the optimization module balances short-term and long-term goals in making such determination.

2. The system of claim 1, further comprising a position analyzer configured to estimate advertiser results on an advertisement framework.

3. The system of claim 2, wherein the position analyzer analyzes impressions and average ad positions to determine and output total impressions, bid ranks, and impression ranges to the estimation and prediction module.

4. The system of claim 1, wherein the estimation and prediction module includes a user model, the user model including a particle filter, the user model being configured to predict information about the consumer including whether the consumer is in a buying state or a browsing state.

5. The system of claim 1, wherein the estimation and prediction module includes an advertiser model, the advertiser model being configured to predict information about advertisers including how much the advertisers are bidding on keywords.

6. The system of claim 5, wherein the advertiser model includes a first estimator and a second estimator and averages modeled information from the first estimator and the second estimator to predict information about advertisers.

7. The system of claim 6, wherein the first estimator uses a particle filter and assumes joint distribution over all advertiser bids and wherein the second estimator assumes distribution over discrete bids with separate distribution for each query.

8. The system of claim 1, wherein the estimation and prediction module includes a parameter model configured to estimate unknown parameters.

9. The system of claim 1, wherein the optimization module includes a query analyzer configured to compute expected outcomes of auctions.

10. The system of claim 6, wherein the expected outcomes of auctions include numbers of clicks and conversions that may occur for a given query type.

11. A method for ad auction optimization comprising:
estimating a likelihood that a consumer will purchase an advertised product, such estimating being performed by an estimation and prediction module;
using the estimated likelihood that a consumer will purchase and balancing short term and long term goals using a multi-day optimizer and a single-day optimizer of an optimization module;
determining modeled data for a keyword in an auction based on the balancing of the short term and long term goals, such determining being performed by an optimization module.

12. The method of claim 6, wherein estimating a likelihood that a consumer will purchase is done using probabilistic filtering.

13. The method of claim 6, wherein estimating a likelihood that a consumer will purchase includes predicting whether the consumer is in a buying state or a browsing state.

14. The method of claim 6, wherein estimating a likelihood that a consumer will purchase includes predicting an amount an advertiser will bid for the keyword.

15. The method of claim 6, wherein estimating a likelihood that a consumer will purchase includes estimating unknown parameters.

16. The method of claim 6, wherein short term goals are assessed by a single-day optimizer and long term goals are assessed by a multi-day optimizer, the single-day optimizer using a greedy optimizer and the multi-day optimizer using a hill climbing search.

17. The method of claim 6, further comprising estimating advertiser results on an advertisement framework using a position analyzer.

18. The method of claim 6, wherein the modeled data comprises daily bids, ads, and spending limits for queries.

19. A computer accessible medium having stored thereon computer executable instructions, which, when executed by a computing device, operably enable the computing device to perform a procedure for ad auction optimization comprising:
estimating a likelihood that a consumer will purchase an advertised product, such estimating being performed by an estimation and prediction module;
using the estimated likelihood that a consumer will purchase and balancing short term and long term goals using a multi-day optimizer and a single-day optimizer of an optimization module;
determining modeled data for a keyword in an auction based on the balancing of the short term and long term goals, such determining being performed by an optimization module.
